(19) United States
(12) Patent Application Publication
(10) Pub. No.: US 2014/0202778 A1
(43) Pub. Date: Jul. 24, 2014

(54) POWERED TRAILER STEERING AND HITCHING ASSIST

(71) Applicants: Richard Terrell Barrett, Weatherford, TX (US); Marc Gray, Weatherford, TX (US)

(72) Inventors: Richard Terrell Barrett, Weatherford, TX (US); Marc Gray, Weatherford, TX (US)

(21) Appl. No.: 13/748,437

(22) Filed: Jan. 23, 2013

(51) Int. Cl. B60S 9/215

(52) U.S. Cl. CPC B60S 9/215
USPC 180/12

(57) ABSTRACT

A stowable powered jack for steering a boat trailer includes an electric motor turning a drive shaft running longitudinally through a support tube which is mounted to a trailer frame. The drive shaft powers a transmission which sits between a pair of wheels driven by a transverse axle. Controls for the motor provide at least forward and reverse motion for wheels. The transmission is sealed within a housing that is swivels in relation to the fixed support tube. An extendable handle facilitates steering.

### BACKGROUND OF THE INVENTION

1. Field of the Invention

The instant invention relates generally to a powered hitching and parking assist for a trailer.

2. Related Art

Maneuvering a vehicle in order to align a ball hitch to a trailer tongue can be a frustrating and time consuming experience. Various electrically powered and manually powered steerable trailer jacks have been described in the past. U.S. Pat. No. 3,439,264 to Kimball discloses a power caster including a three-wheeled apparatus with electric motor that is coupled to the bottom of a trailer jack tube and includes a cord that is plugged into a wall receptacle for powering the motor. U.S. Pat. No. 6,945,343 to Moreau et al. discloses an electrically driven trailer wheel mounted to the bottom of a trailer jack tube wherein a motor driven pinion is engaged with a circular rack as part of the wheel. U.S. Pat. No. 6,779,616 to Brown, discloses a motorized trailer jack with powered height adjustment means.

It is not uncommon for a 18 foot boat and trailer combination to weigh in excess of 4500 lbs. Many residential driveways have uneven surfaces, or possess an incline or downward sloping leading to an alleyway or street which complicates the hitching operation. While the aforementioned devices no doubt offer advantages over manually powered jacks when aligning a trailer tongue to a ball hitch or parking the trailer, difficulties remain. One issue is that drive chains used in many such devices are prone to breakage under load and subject to fouling with road debris. Frequent maintenance requires accessibility to the drive components in the form of partial shrouding which perpetuates the problem. Another issue is that while such devices are suitable for relatively light trailer loads on level surfaces, they are unsuited to moving heavily laden trailers or even moderately laden trailers on slippery and uneven surfaces. A dependable sure-footed means for steering boat trailers is needed.

### SUMMARY

In an aspect of the instant invention, a steerable powered trailer jack assembly includes a powering means which is preferably an electric motor powered by a dc power source, a steering means which includes a handle that swivels a lower portion of the jack assembly having a pair of wheels, and, a means of transmitting force to an axle to which wheels are fixed. The provided transmission is sealed within a housing and supported between two wheels affixed to the ends of a transverse axle extending from both sides of the housing and employs a high-torque worm drive to rotate the axle. Both wheels move in the same direction rotating with the axle. Preferably, the wheels are attached via a hub affixed to each end of the axle by bushings or other suitable means that will suggest itself to those having skill in the art.

The electric motor of the jack can be powered by a battery; whether direct connection to the battery of the towing vehicle, an extended power cord plugged into an electric jack of the towing vehicle, or by a separate battery mounted to the jack or the trailer frame. Typically, the battery will be of the 12 volt type found in vehicles and boats.

The particular characteristics of the instant invention provide an ideal solution to for boat owners when aligning and hitching heavily laden trailers.

Location of the transmission between the wheel pair, and inline with the vertical drive shaft means that the shaft is stably supported over uneven surfaces with a axle track of at least 6 inches.

The axle track of the instant invention provides sufficient traction when moving heavy trailers up or down an incline.

The components of the instant invention are compact, durable and comprise an assembly that can be detached from the frame and stowed in the vehicle, or pivoted out of the way if connected to the trailer frame with a pivoting bracket.

The foregoing and other objects, features, and advantages of the invention will become more apparent from the following detailed description, which proceeds with reference to the accompanying figures.

### BRIEF DESCRIPTION OF THE DRAWINGS

FIG. 1 is a front perspective view of an apparatus for steering a boat trailer according to the instant invention;

FIG. 2 is a front perspective view of an apparatus for steering a boat trailer according to the instant invention, showing the protective shroud removed;

FIG. 3 is an enlarged view of the motor housing and motion controls;

FIG. 4 is a detail view of the lower sub-assembly;

FIG. 5 is an exploded view of the interior of one half of a transmission case with worm drive components typical of the kind employed by the present invention;

FIG. 6 is a perspective view of the crank assembly;

FIG. 7 is a perspective view of one embodiment of the present invention coupled to a boat trailer.

### DETAILED DESCRIPTION OF THE INVENTION

### REFERENCE LISTING

100 steerable trailer jack
101 upper sub-assembly
102 support tube
104 rack
106 crank assembly
108a crank
108b bracket
110 handle
112 motor
113 gear reduction box
114 motor housing
116 motion controls
117 light
118 drive shaft
119 lower sub-assembly
120 mounting plate
122 bearing
124 transmission
124a clutch
125 transmission housing
126 axle
128 wheel hub
130 tire
132 power cord
134 battery
200 trailer tongue

### DEFINITIONS

In the following description, the term “powered” refers to an electric powering means such as a combination of an electric motor and a power source for electric current whether ac or dc. The term “enclosed” is used interchangeably with the term “sealed” and generally refers to sealing or encasing in order to protect vulnerable parts from dust, debris and the elements. The term “axle track” refers to the distance between the center line of two wheels on the same axle. The term “high traction” refers generally to the resistance to slippage provided by the particular parts of the instant invention working together for that effect; in particular a relatively greater footprint for the wheels, the particular transmission employed, and the arrangement of the transmission and the wheels. Unless otherwise explained, any technical terms used herein have the same meaning as commonly understood by one of ordinary skill in the art to which this disclosure belongs. The singular terms “a,” “an,” and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” Publications, patent applications, patents, and other references mentioned herein, if any, are incorporated by reference in their entirety for all purposes. In case of conflict, the instant specification, including explanations of terms, will control. In addition, the materials, methods, and examples are illustrative only and not intended to be limiting.

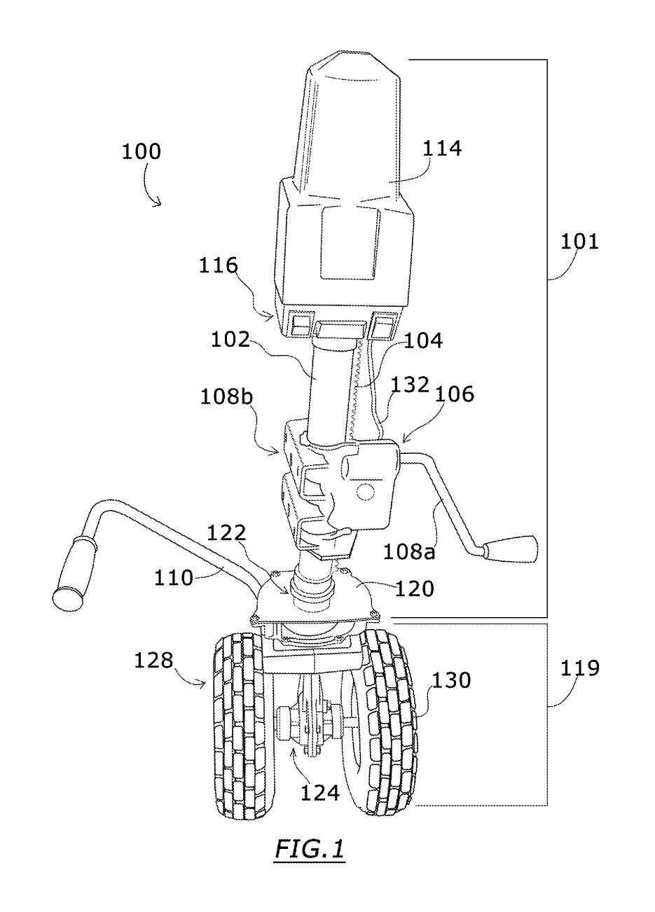

Referring generally to FIGS. 1-7 a powered, steerable trailer jack assembly 100 includes an (1) upper sub-assembly 101 comprising a support tube 102 which is mountable to the tongue 200 portion of a trailer frame via frame attachment bracket 108b, and (2) a lower sub-assembly which includes a transmission 124, wheels 128 and mounting plate 120 between the lower end of the support tube and the transmission housing 125. A drive shaft 118 (not shown) resides within the support tube between the motor and the transmission and is coupled to the motor shaft by any suitable means which can include mating flanges at the shaft ends, a split bushing over both; and bridging shaft ends, or other coupling means appreciated by those having skill in the art.

Preferably, the motive means for the disclosed embodiments is a dc driven motor, with current supplied by a battery 134 mounted on the trailer frame, or by a power cord 132 plugged into a 12v power jack of the towing vehicle, such as a trailer light jack. Conceivably however, the invention can use ac power with the use of an appropriate ac to dc adapter. It is also conceivable that a rechargeable battery pack can be used with the jack as in the case of cordless power tools. Various other configurations for powering the instant invention will suggest themselves to those having skill in the art and benefit of this disclosure.

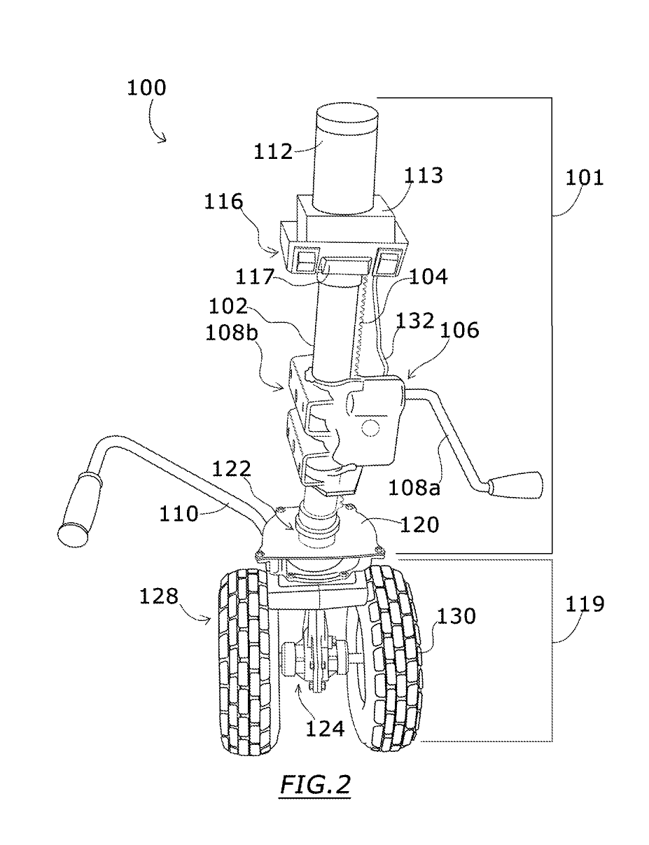

Turning to FIGS. 1 and 2, front perspective views of a preferred embodiment according to the instant invention show a steerable jack assembly 100 which includes a top mounted motor 112 with gear reduction box 113, housing 114, motion controls 116 including forward, reverse and stop, a support tube 102 extending downwardly from the motor housing, a rack 104 down the side of the support tube, a crank assembly 106 with a hand operated crank 108a, and a frame attachment bracket 108b. The crank assembly includes a worm or pinion meshed with the rack for raising and lowering the trailer tongue via crank handle. Mounting plate 120 resides between a sealed transmission housing 125 and the bottom of the support tube. The mounting plate possesses a tubular extension that seats with bearing 122 enabling the lower sub-assembly to swivel relative to the fixed support tube. Other swiveling means will suggest themselves to those having skill in the art. Steering handle 110 extends from the mounting plate and swivels the wheels. A lower sub-assembly 119 includes a pair of wheel hubs 128 affixed to axle 126 which extends transversely from the transmission case. Bearing 122 permits the mounting plate, and transmission to swivel when steering handle 110 is moved.

Depending on the connection between the support tube and the mounting plate, the entire support tube including the motor housing can swivel. In this case, rack 104 is connected at the bottom to bearing 122, but otherwise not joined to the support tube 102. Because the crank assembly is attached to the trailer frame in a fixed position by brackets 108b, the rack 104 meshed with the crank assembly 106 does not rotate when the powered jack assembly 100 is steered by handle 110, while the support tube 102, motor housing 114 and lower sub-assembly 119 turn.

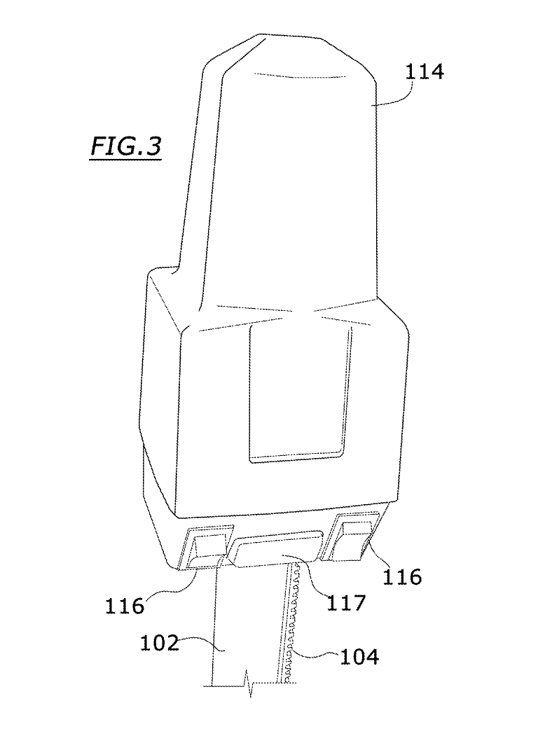

FIG. 3 is a enlarged view of motor housing 114. The housing is made of any suitable weather resistant material covers and protects electrical connections. The motor is responsive to motion controls 116 which are shown preferably located on a lower portion of the motor housing, but which may be located anywhere on the entire assembly. Conceivably, the motion controls can be via a wired or wireless hand held controller or fob (not shown). While preferably, the motion controls are equipped with forward and reverse momentary rocker switches which switch motor polarity, other types of switches can be used. Light 117 resides between the momentary switches and is activated by pressing the lamp cover.

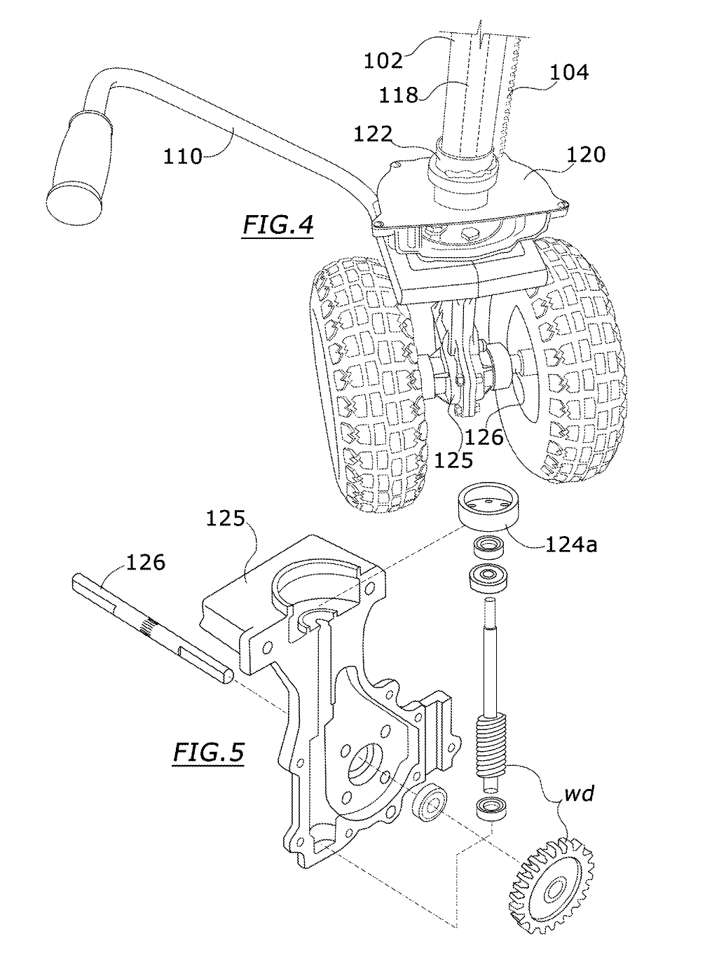

FIG. 4 is a perspective view of the lower jack sub-assembly including bearing 122, mounting plate 120, transmission housing 125 and a pair of wheels affixed to axle 126 transverse to the transmission case. Preferably, the axle is coupled to worm gear transmission (FIG. 5) having a main gear and engaged worm that is coupled to the drive shaft which is driven by electric motor 112 via drive shaft 118 which allows the jack to push or pull heavily laden trailers without slipping or bogging, even when pushing or pulling a trailer up an incline. Preferably, wheel hubs 128 are paired to knobby tread tires which may be pneumatic type, solid type or foam-filled flat-free tires.

FIG. 5 is an isometric view showing one-half of a clam-shell transmission housing 125, bearings, axle 126, worm drive (wd), and clutch 124a. Dashed lines illustrate the relative positions of the components when seated. The sealed case shields the enclosed gears from dust, debris and the elements, and the enclosed transmission typically requires no servicing. While a worm drive is preferred as it is self locking when not driven and capable of high-torque, other transmission configurations will suggest themselves to those having skill in the art without departing from the present invention.

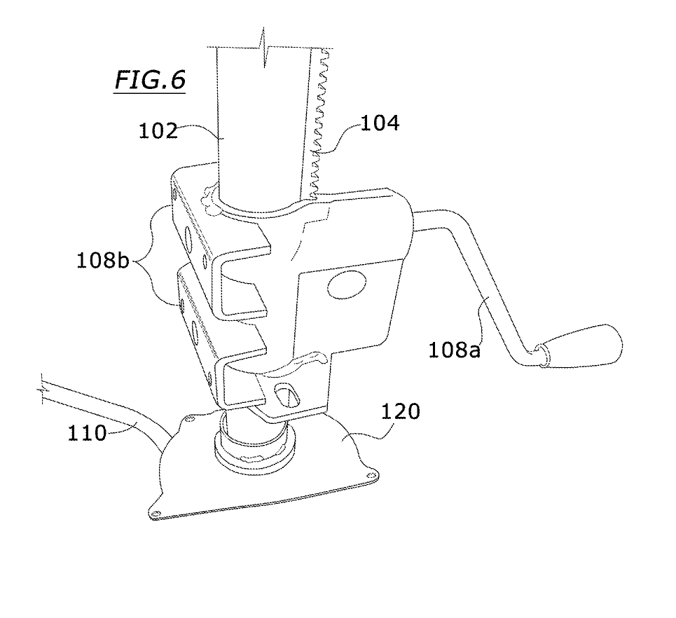

FIG. 6 is an enlarged perspective view of crank assembly 106 with crank handle 108a that actuates a worm or pinion (not shown) that is engaged with rack teeth 104. Although the particular embodiment disclosed shows a manual crank providing height adjustment, it is conceivable that the invention can be used with powered height adjustments means if an electric motor is employed to turn the worm/pinion rather than the crank handle shown.

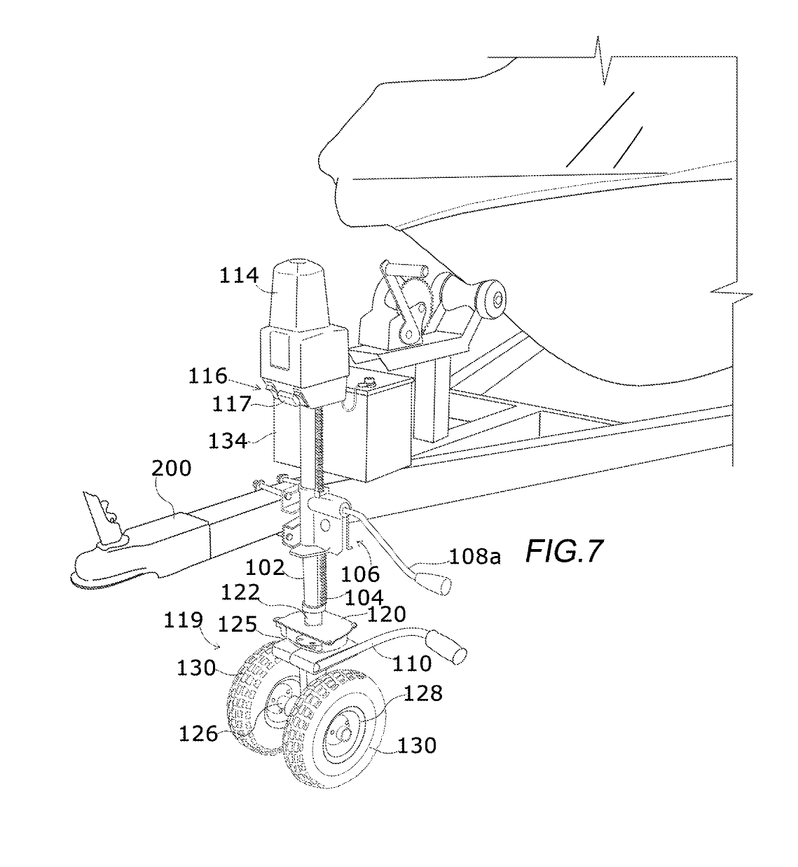

FIG. 7 is a perspective view of the jack assembly of the present invention mounted to a trailer frame by attachment bracket 108b. Persons skilled in the art will appreciate that various attachment means for attaching the crank assembly to a trailer frame. It is conceivable that a pivot (not shown) can be attached to brackets 108b in order to pivot the assembly to a position where it is either substantially parallel to the trailer frame or crossways the frame. Accordingly, the instant invention is considered to encompass such alternate configurations.

It should be noted that the instant invention is generally applicable to the alignment of trailer tongue and parking of trailers, and should not be construed as being limited to boat trailers. In view of the many possible embodiments to which the principles of the disclosed invention may be applied, it should be recognized that the illustrated embodiments are only preferred examples of the invention and should not be taken as limiting the scope of the invention. Therefore, this disclosure is intended to cover such alternatives, modifications, and equivalents as may be included in the spirit and scope of the description in view of the appended drawings and claims.

We claim:

1. A stowable powered trailer jack assembly for steering a boat trailer comprising:
(1) a support tube mounted to a trailer frame, the tube terminating at one end with a mounting plate and having a rotatable drive shaft therethrough,
(2) a swivelable sub-assembly including a transmission between wheels mounted to a transverse axle,
(3) an electric motor mounted to an end of the support tube opposite the mounting plate for driving the transmission via the drive shaft.

2. The jack assembly according to claim 1, in which the transmission drive elements are fully enclosed.

3. The jack assembly according to claim 1, wherein the wheels possess an axle track of at least 6 inches.

4. The jack assembly according to claim 1, further comprising a steering handle.

5. The jack assembly according to claim 1, further comprising at least forward and reverse motion controls.
